(19) United States
(12) Patent Application Publication
(10) Pub. No.: US 2026/0130380 A1
(43) Pub. Date: May 14, 2026

(54) METHOD AND APPARATUS FOR MAKING JIANBING

(71) Applicant: Peiming TIAN, Tianjin (CN)

(72) Inventor: Peiming TIAN, Tianjin (CN)

(21) Appl. No.: 18/986,448

(22) Filed: Dec. 18, 2024

(30) Foreign Application Priority Data
Nov. 12, 2024 (CN) 2024116117803

(51) Int. Cl. A21D 2/36; A21D 2/34; A21D 6/00; A21D 13/062; A23L 11/45; A23L 21/25

(52) U.S. Cl. CPC A21D 2/362; A21D 2/34; A21D 6/003; A21D 13/062; A23L 11/45; A23L 21/25

(57) ABSTRACT

The present disclosure provides a method for making jianbing, comprising: mixing, in parts by weight, 150 parts mung bean flour, 50 parts millet flour, 3 parts salt, 0.6 parts aroma-enhancing powder, 1.5 parts five-spice powder, and 300 parts water. First, combine the dry ingredients in a vessel and mix thoroughly. Add 180 parts of water, stirring to form a uniform batter. Gradually add the remaining 120 parts of water, stirring to obtain a smooth second batter. Seal the vessel and let the batter rest. Heat a jianbing pan to a predetermined temperature. Pour a measured amount of batter onto the pan, spreading it evenly. Sprinkle pre-made materials on the batter while cooking. Flip the jianbing to cook the other side and apply sauce to the top surface. Finally, roll the jianbing with crispy pre-made baocui into a reel or fold into a cake shape.

### FIELD OF THE INVENTION

The present disclosure relates to the field of food preparation and processing, and particularly, to a method and apparatus for making jianbing.

### BACKGROUND ART

As traditional Chinese food, jianbing is widely loved because of their unique taste and rich nutrition. There are various methods for making traditional jianbing. Jianbing is usually made from wheat flour, corn flour or rice flour as main raw materials, with auxiliary material such as eggs and vegetables, by formulating, mixing and frying. Although the process of making jianbing has been inherited for many years, there are still some problems in practical production, such as the problems from the diversity of batter raw materials, the taste of sauce, temperature control, etc. These factors directly affect the taste and quality of jianbing.

In recent years, as consumers' demands for food health and convenience have increased, methods for making traditional jianbing are facing innovative challenges. The development of modern science and technologies offers new possibilities for the preparation of jianbing, such as the use of new flour substitutes, improved formulations, etc. These innovations may not only improve the flavors and nutritional value of jianbing, but also improve the taste of jianbing to meet demands for diversified, quality-oriented, and personalized foods in the market. Therefore, it is of important practical significance and market potential to develop a new method and apparatus for making jianbing, which are capable of effectively solving the drawbacks in the prior art, and improving the preparation efficiency and quality of jianbing.

### SUMMARY OF THE INVENTION

Embodiments of the present disclosure provide a method for making Jianbing.

In a first aspect, embodiments of the present disclosure provide a method for making jianbing, comprising the following steps:
step S101: taking batter raw materials in the following parts by weight: 150 parts of mung bean flour, 50 parts of millet flour, 3 parts of salt, 0.6 parts of freshness and aroma enhancing powder, 1.5 parts of five-spice powder, and 300 parts of water;
step S102: placing the mung bean flour, millet flour, salt, freshness and aroma enhancing powder and five-spice powder obtained at step 101 into a first vessel, and stirring uniformly to obtain a mixed raw material;
step S103: adding 180 parts of water to the mixed raw material in the first vessel, and stirring uniformly to obtain a first batter;
step S104: adding remaining 120 parts of water to the first batter and stirring uniformly to obtain a second batter;
step S105: sealing the first vessel containing the second batter with a thin film, and after letting the second batter stand still for 10-15 hours or over night, removing water from a surface layer to obtain a jianbing batter;
step S106: taking sauce raw materials in the following parts by weight: 50 parts of sweet bean sauce, 2.5 parts of honey, 2.5 parts of sugar and 10 parts of fermented tofu;
step S107: placing the sauce raw materials obtained at step S106 into a second vessel;
step S108: placing the second vessel in a steamer to steam for 2-8 minutes to obtain a sauce, or heating the second vessel to a temperature in a range of 150° C.-160° C. for 2-8 minutes to obtain a sauce;
step S109: heating the jianbing pan and continuously maintaining the jianbing pan at a predetermined temperature, taking a predetermined amount of the jianbing batter obtained at step S105 and placing the same on the jianbing pan, and uniformly spreading he jianbing batter and maintaining the jianbing batter for 10-30 seconds to solidify the jianbing batter into a jianbing;
step S110: covering at least a portion of a first surface of the jianbing with egg liquid of eggs and spreading a pre-made material on the at least a portion of the first surface;
step S111: turning the jianbing obtained at step S110 over so that the first surface of the jianbing is in contact with the jianbing pan, and applying a predetermined amount of the sauce obtained at step S108 on a second surface of the jianbing;
step S112: placing a pre-made baocui on the second surface of the jianbing and rolling the jianbing and the pre-made baocui together into a reel shape or folding them into a pancake shape.

In a second aspect, embodiments of the present disclosure provide a jianbing made from raw materials in the following parts by weight: 150 parts of mung bean flour, 50 parts of millet flour, 3 parts of salt, 0.6 parts of fresh fragrance powder, 1.5 parts of five-spice powder, and 300 parts of water, wherein the jianbing is made using the step S101 through step S112 as described above.

Compared with the prior art, the present disclosure has the following advantages:

The jianbing made by the method according to the embodiments of the present disclosure have good flavor, rich nutritional value and superior mouthfeel, and meet demands for diversified, high-quality and personalized food in the market.

The above description is merely an overview of the technical solution of the present disclosure. In order to make the technical means of the present disclosure more apparent, the present disclosure may be implemented according to the content of the description. In addition, specific implementations of the present disclosure will be listed below to make the above and other objects, features and advantages of the present disclosure more apparent.

### BRIEF DESCRIPTION OF THE DRAWINGS

In the drawings, the same reference numerals denote the same or like parts or elements throughout a plurality of figures unless otherwise specified. The figures are not necessarily drawn to scale. It should be appreciated that these figures only depict some implementations according to the present disclosure and should not be construed as limiting the scope of the present disclosure.

FIG. 1 shows a flow chart of an embodiment of a method for making jianbing according to the present disclosure;

FIG. 2 shows a flow chart of a method for making a pre-made baocui in the method for making jianbing according to the present disclosure; and

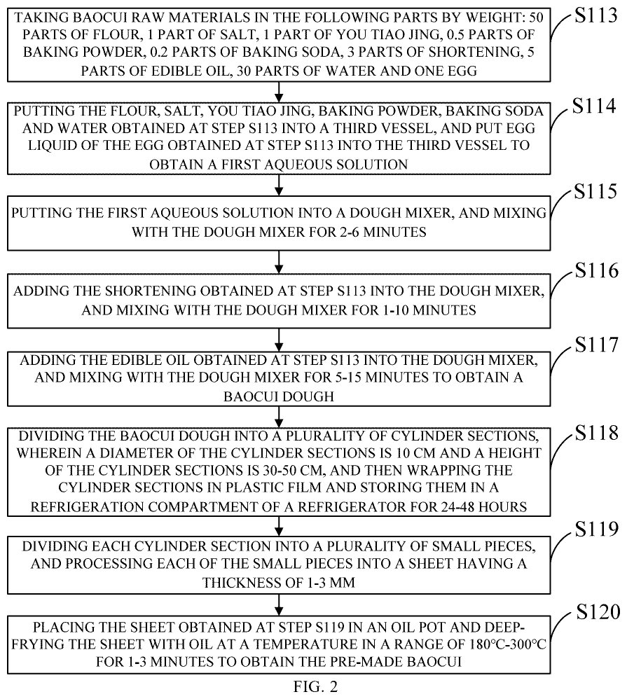

FIG. 3 shows an apparatus for making jianbing according to the present disclosure.

### DETAILED DESCRIPTION OF EMBODIMENTS

Some example embodiments are only briefly described hereunder. As will be recognized by those skilled in the art, the described embodiments may be modified in various ways without departing from the spirit or scope of the present disclosure. Accordingly, the drawings and description are to be regarded as being illustrative in essence, and not as being restrictive.

Relevant techniques of embodiments of the present disclosure will be described hereunder to help understand the technical solutions of embodiments of the present disclosure. The following relevant techniques, as optional solutions, may be arbitrarily combined with the technical solutions of the embodiments of the present disclosure, and all the combinations fall within the scope of protection of the embodiments of the present disclosure.

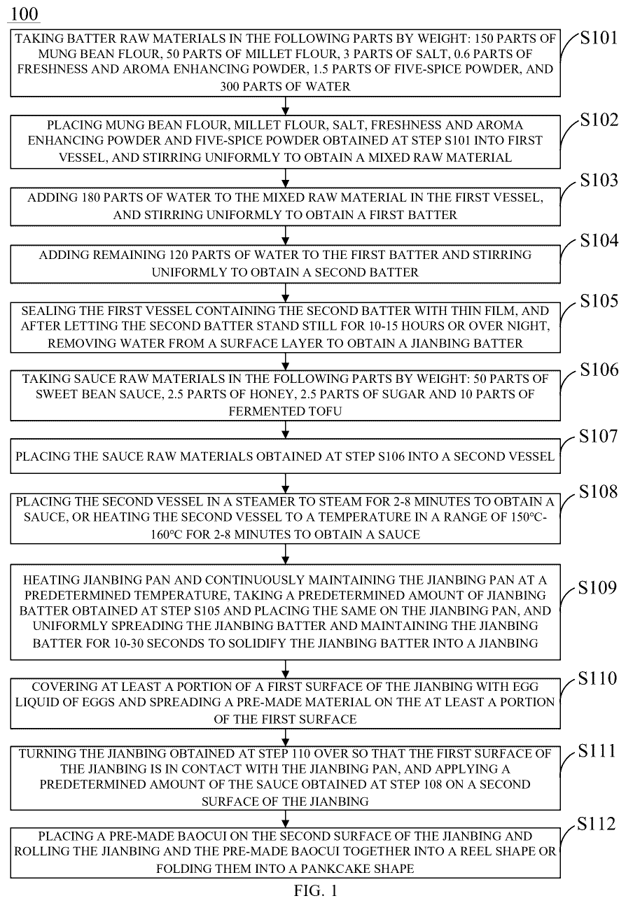

The present disclosure discloses a method for making jianbing. FIG. 1 shows a flow chart of an embodiment of a method 100 for making jianbing according to the present disclosure.

The method 100 for making jianbing comprises the following steps S101 to S112. The steps will be described in detail below in conjunction with content of specific implementations.

First, the process proceeds to step S101. At step S101, taking batter raw materials according to the following parts by weight: 150 parts of mung bean flour, 50 parts of millet flour, 3 parts of salt, 0.6 parts of freshness and aroma enhancing powder, 1.5 parts of five-spice powder, and 300 parts of water.

It should be noted that “parts by weight” described in the present disclosure means a weight ratio between components, for example, “150 parts of mung bean flour, 50 parts of millet flour” means that the weight of mung bean flour is 3 times that of the millet flour. In practice, each of the parts by weight may correspond to a certain weight, for example, if each of the parts by weight corresponds to 10 grams, then “150 parts of mung bean flour, 50 parts of millet flour, 3 parts of salt” may represent mung bean flour 1500 g, millet flour 500 g, and salt 30 g.

The water may be tap water, mineral water, purified water, etc. or may be cool boiled water obtained by boiling water and then letting it cool down to an ambient temperature. Since purified water does not contain an alkaline component, it may keep the original tastes and flavors of other batter raw materials as much as possible in subsequent processing steps. Therefore, the purified water is preferably used as one of the batter raw materials. Those skilled in the art may choose the type of the water in the batter raw materials according to actual situations.

Generally, the mesh of the mung bean flour and the millet flour is smaller than or equal to 80. In one embodiment, mung bean flour and millet flour having a mesh size greater than 100 mesh are selected and used, and more preferably, mung bean flour and millet flour having a mesh size greater than 120 mesh are used. Flour with a larger mesh size has a finer texture and is easier to mix with other batter raw materials, and is easier to process and shape in the subsequent steps, and also results in a better taste of the finished jianbing.

The freshness and aroma enhancing powder and the five-spice powder mainly function to improve freshness and fragrance so that the taste of the finished jianbing is more delicious.

The parts by weight of the various batter raw materials described in the above step S101 are merely one case disclosed in the present disclosure, and other parts by weight may also be used in the method for making jianbing according to the present disclosure. For example, in one embodiment, the parts by weight of the batter raw materials are: 100-200 parts of mung bean flour, 20-100 parts of millet flour, 1-8 parts of salt, 0.2-1 parts of freshness and aroma enhancing powder, 0.2-2 parts of five-spice powder, and 200-500 parts of water. In other words, the parts by weight of the batter raw materials may be selected differently depending on the dietary habits of different consumers. For example, if a consumer prefers a jianbing made of salty mung bean flour, the part by weight of the mung bean flour and the part by weight of the salt may be increased; if a consumer likes a jianbing made of millet flour with less salt, the part by weight of the millet flour may be increased and the part by weight of salt may be decreased.

Optionally, the batter raw materials obtained at step S101 may further comprise: three parts by weight of fruit juice. The addition of fruit juice to the batter raw materials provides the finished jianbing with fruit aroma, increases nutritional components, and improves the mouthfeel. The fruit juice may be one or more of apple juice, pineapple juice, orange juice, watermelon juice, pear juice, dragon fruit juice, and the like.

Next, the process proceeds to step S102. At step S102, the mung bean flour, millet flour, salt, freshness and aroma enhancing powder, and five-spice powder obtained at step S101 are put into a first vessel and stirred uniformly to obtain a mixed raw material.

The first vessel may be any one of a pot, a bowl, a ladle, and a basin, as long as it can function to mix and contain the mixed raw material. An operator making jianbing may stir the above-mentioned various batter raw materials by hand, or may stir them using tools such as a mixer, chopsticks, and a spoon, as long as the batter raw materials can be uniformly stirred.

It should be appreciated by those skilled in the art that the so-called “uniformly stirred” here describes a state in which the various batter raw materials have been thoroughly mixed, and that the time taken to achieve such a “uniformly stirred” state may vary with the tools used for stirring. For example, if a mixer is used to mix the batter raw materials, it may take 10 to 20 seconds to reach the “uniformly stirred” state; if chopsticks are used to stir the batter raw materials, it may take 30 to 60 seconds (or even longer) to reach the “uniformly stirred” state.

In one embodiment, the step S102 further comprises: prior to putting the mung bean flour and the millet flour into the first vessel, passing the mung bean flour and the millet flour through a 120 mesh sieve. As described above, finer flour may be obtained by using a sieve with a larger mesh number, thereby facilitating subsequent steps and improving the taste of the jianbing. Preferably, a sieve having a mesh of more than 120, for example 150, may also be used at step S102.

Then, the process proceeds to step S103. At step S103, 180 parts by weight of water is added to the mixed raw material in the first vessel and stirred uniformly to obtain a first batter.

Usually, in an initial stage of adding water to the mixed raw material to obtain the batter, it is not desirable to directly add all the water at one time, but add all the water in two times to prevent the mixed raw material from exhibiting an adhered, “pilling” state after meeting a large amount of water. In the present embodiment, 60% of all the water (i.e., 300 parts×60%=180 parts) is added, then stirring is performed to allow the mixed raw material to be sufficiently mixed with the water, and then the remaining water (i.e., 120 parts) is added.

In one embodiment, prior to step S103, the making method 100 further comprises heating the water to a temperature in a range of 30° C.-50° C. In other words, at step S103, the water added into the first vessel may be warm water. Preferably, the water may be heated to a temperature in a range 30° C.-50° C.; more preferably, the water may be heated to 40° C. With the warm water being used at step S103, on the one hand, the mixed raw material may be allowed to mix with water in a quicker and better manner, and on the other hand, a fermented state of the batter of the jianbing may be improved by the heat of the water, thereby improving the softness and chewiness of the jianbing and improving the taste of the jianbing.

Then, the process proceeds to step S104. At step S104, the remaining 120 parts of water are added to the first batter, and the first batter and the water are stirred uniformly to obtain a second batter.

As described above, the addition of water in two times prevents the mixed raw material from exhibiting an adhered, “pilling” state after meeting a large amount of water. The water added at step S104 may also be preheated to a temperature in the range of 30° C.-50° C.

Then, the process proceeds to step S105. At step S105, the first vessel containing the second batter is sealed with a thin film, and after the second batter stands still for 10-15 hours or over night, water at the surface of the second batter is removed to obtain a jianbing batter.

Preferably, at step S105, the second batter may be placed still over night, i.e., the second batter is used after night. For example, after the user makes the second batter through the above steps this afternoon, the second batter is placed still and the water at the surface layer is removed tomorrow morning or before noon to obtain the jianbing batter, and then subsequent jianbing processing steps are performed. Placing the second batter still and over night helps to allow the jianbing batter to ferment sufficiently, remove air bubbles from the jianbing batter and make the jianbing softer.

The thin film is preferably one that meets food safety standards. The use of the thin film to seal the first vessel prevents, on the one hand, the frequent exchange of air inside and outside the first vessel during the standstill period which causes rapid spoilage of the jianbing batter and, on the other hand, prevents dust, debris, etc. from falling into the jianbing batter and causing food contamination.

In one embodiment, the first vessel is allowed to stand still for 10-15 hours or over night. It should be noted that the standstill time of the first vessel varies with the level of the outside air temperature. If the outside air temperature is high, the first vessel is preferably allowed to stand still for 10 hours to prevent the jianbing batter from spoiling; if the outside air temperature is low, the standstill time may be extended.

After a long standstill time, a small amount of water in the jianbing batter will ooze out and float on an upper layer of the jianbing batter, and the presence of such water will affect subsequent steps. For example, during the subsequent heating of the jianbing batter, the water will extend the time for frying the jianbing batter done, thereby increasing energy consumption and also increasing the waiting time of the consumer, and affecting the user's experience. Therefore, it is necessary to remove the water at the surface after the jianbing batter is left still. Preferably, the operator may use a water-removing tool commonly found in a kitchen or may tilt the first vessel by hand at an angle to pour out the water from the surface of the jianbing batter.

Preferably, the standing still for 10-15 hours or over night at step S105 comprises: placing the first vessel sealed with the thin film in a refrigeration compartment of a refrigerator for 10-15 hours or over night. In other words, the “standstill” operation may occur in the refrigeration compartment of the refrigerator. Placing the jianbing batter still in a long time at a low temperature may, on the one hand, facilitate keeping the jianbing batter fresh, and on the other hand, make the batter components of the jianbing batter more viscous and tough and increase the taste of the jianbing.

The jianbing batter obtained from the above-mentioned step S101 through step S105, will be used in other subsequent steps of the method 100 for making jianbing. The making of jianbing requires not only preparation of the jianbing batter but also preparation of a sauce to be applied to a surface or both surfaces of the jianbing during the jianbing making to increase the flavor of the jianbing. The following step S106 through step S108 describe steps of making the sauce used in the method for making jianbing according to the present disclosure.

Then, the process proceeds to step S106. At step S106, sauce raw materials are taken in the following parts by weight: 50 parts of sweet bean sauce, 2.5 parts of honey, 2.5 parts of sugar and 10 parts of fermented tofu.

The proportions of the sweet bean source, honey, sugar and fermented tofu (also referred to as “fermented bean curd”) in the sauce raw materials may be set according to the taste chosen by the consumer. For example, if a consumer likes a sweet taste, the parts by weight of honey and sugar may be increased. Preferably, the sauce raw materials may be taken in parts by weight at step S106: 50 parts of sweet bean sauce, 5 parts of honey, 5 parts of sugar, and 10 parts of fermented tofu.

Preferably, in order to increase the flavor and mouthfeel of the sauce, the sauce raw materials taken at step S106 may further comprise: soy sauce 1 part, vinegar 1 part, sesame oil 2 parts.

Then, the process proceeds to step S107. At step S107, the sauce raw materials obtained at step S106 is put into a second vessel.

The second vessel may be a metal vessel or a ceramic vessel. Preferably, the second vessel is a stainless steel basin. Preferably, the second vessel is a ceramic bowl. Those skilled in the art may choose the second vessel as actually needed as long as the principles of the present disclosure can be realized.

Then, the process proceeds to step S108. At step S108, the second vessel is placed into a steamer to steam for 2-8 minutes to obtain a sauce, or the second vessel is heated to a temperature in a range of 150° C.-160° C. for 2-8 minutes to obtain a sauce.

The second container containing the sauce raw materials is placed in a steamer for steaming or heating, so that the sauce raw materials can be made into a mature sauce, thereby making the sauce have a stronger and more fragrant flavor.

The steaming duration or heating duration of the second vessel in the steamer varies with the proportions of components in the source raw materials. Preferably, the steaming duration or the heating duration may be 5 to 6 minutes.

Then, the process proceeds to step S109. At step S109, a jianbing pan is heated and continuously maintained at a predetermined temperature, a predetermined amount of the jianbing batter obtained at step S105 is placed on the jianbing pan, and the jianbing batter is evenly spread and maintained for 10-60 seconds to solidify into a jianbing.

Preferably, the predetermined temperature of the pan is in a range of 150° C.-400° C. The predetermined temperature may be set correspondingly according to different proportions of the components of the jianbing batter, requirements for the preparation speed of the jianbing, etc., and the predetermined temperature of the jianbing pan may also be adjusted at different stages of the preparation process of the jianbing. For example, in the first few tens of seconds after the jianbing batter is just placed on the jianbing pan, the predetermined temperature may be set in a range of 200° C.-400° C. to rapidly solidify and shape the jianbing batter; thereafter, the predetermined temperature is adjusted to a temperature in a range of 150° C.-200° C. to avoid the burning of the finished jianbing products.

Preferably, a jianbing operation rod may be used to spread the jianbing batter over the pan. The jianbing operation rod may be made of wood, plastic or metal.

Then, the process proceeds to step S110. At step S110, egg liquid of an egg is applied on at least a portion of a first surface of the jianbing and a pre-made filling is sprinkled on the at least a portion of the first surface.

Preferably, before the step S110, egg liquid of a predetermined number of eggs may be put into a fourth vessel in advance, and the egg liquid may be uniformly stirred. In other words, it is possible to put egg liquid of a plurality of eggs into the fourth vessel and stir the egg liquid, and then pour the egg liquid on the first surface of the jianbing at step S110, and then use the jianbing operation rod to apply the egg liquid on at least a portion of the first surface of the jianbing. The first surface of the jianbing is the surface of the jianbing facing away from the pan, i.e., the upward-facing surface of the jianbing at the moment. Preferably, the at least one portion is an entire surface of the upwardly-facing side of the jianbing. In order to prevent the egg liquid from spilling from the surface of the jianbing, the at least one portion may be only a portion near the middle of the upwardly-facing side of the jianbing. The fourth vessel may be any one of a pot, a bowl, a ladle and a basin, as long as it can function to contain the egg liquid.

The pre-made material may comprise: one or more of Chinese onion, coriander, meat product, fruit product, etc. The addition of the pre-made filling may, on the one hand, increase the nutrition of the jianbing product and, on the other hand, improve the mouthfeel of the jianbing product and improve the user's experience.

Then, the process proceeds to step S111. At step S111, the jianbing obtained at step S110 is turned over so that the first surface of the jianbing is in contact with the jianbing pan, and a predetermined amount of the sauce obtained at step S108 is applied on the second surface of the jianbing.

The purpose of turning over the jianbing is to bring the first surface of the jianbing into contact with the pan to accelerate the processing speed of the first surface of the jianbing and to make the mouthfeel of both sides of the jianbing similar or same, thereby improving the user's experience. The second surface of the jianbing, which is the surface in contact with the jianbing pan at step S109-step S110, faces upwards after being turned over. The purpose of applying the sauce obtained at step S108 on the second surface is to make the jianbing possess the flavor of the sauce, thereby improving the taste of the jianbing. One or more of a jianbing operation rod, a spoon, a brush, a spatula, etc., may be used to apply the sauce onto the second surface.

Then, the process proceeds to step S112. At step S112, a pre-made baocui is placed on the second surface of the jianbing, and the jianbing and the pre-made baocui are together rolled into a reel shape or folded into a pancake shape.

Sandwiching or rolling the pre-made baocui in the jianbing may, on the one hand, improve the mouthfeel of the jianbing and, on the other hand, improve the satiation of the consumer. One or more of tools such as a jianbing operation rod, a spatula, chopsticks, etc., may be used to roll the jianbing and the pre-made baocui together into a reel shape or fold them into a pancake shape.

So far, a complete finished jianbing is obtained, and the steps of making the jianbing end.

A method for making the pre-made baocui used at step S112 is described below. The pre-made baocui is made by the following step S113 through step S119.

First, the process proceeds to step S113. At step S113, baocui raw materials are taken in the following parts by weight: 50 parts of flour, 1 part of salt, 1 part of You Tiao Jing, 0.5 parts of baking powder, 0.2 parts of baking soda, 3 parts of shortening, 5 parts of edible oil, 30 parts of water, and one egg.

The baking powder, baking soda and shortening function to make the pre-made baocui taste crisp. Preferably, the proportion of eggs in the baocui raw materials may be suitably increased to improve the mouthfeel and color of the pre-made baocui. 2 parts of honey or 2 parts of sugar may be added to the baocui raw materials to increase the sweetness of the pre-made baocui and improve the mouthfeel. 1 part of fruit juice may be added to the pre-made baocui raw materials, so that the pre-made baocui has a fruity flavor and an improved mouthfeel. The juice may be one or more of apple juice, pineapple juice, orange juice, watermelon juice, pear juice, dragon fruit juice, and the like.

Then, the process proceeds to step S114. At step S114, the flour, salt, You Tiao Jing, baking powder, baking soda and water obtained at step S113 are put into a third vessel, and the egg liquid obtained in step S113 is beaten into the third vessel to obtain a first aqueous solution.

The third vessel may be any one of a pot, a bowl, a ladle, and a basin, as long as it can function to mix and contain the mixed raw material.

Then, the process proceeds to step S115. At step S115, the first aqueous solution is put into a dough mixer, and mixed by the dough mixer for 2-6 minutes.

The dough mixer is capable of stirring the first aqueous solution to form a batter and providing a basis for subsequent steps. The dough-mixing duration may be adjusted according to the desired mouthfeel and flavor of the baocui, composition of the baocui raw materials, etc. Preferably, the dough-mixing duration may be 4-5 minutes.

The process proceeds to step S116. At step S116, the shortening obtained at step S113 is added to the dough mixer and mixed with the dough mixer for 1-10 minutes.

The effect of the addition of shortening is to ferment the batter, thereby increasing the crispness of the pre-made baocui product. The dough-mixing duration after the addition of the shortening may be adjusted according to the actual needs, the desired baocui taste and flavor, etc., and preferably the dough mixing duration may be 7-10 minutes.

Then, the process proceeds to step S117. At step S117, the edible oil obtained at step S113 is added into the dough mixer, and mixed by the dough mixer for 5-15 minutes to obtain a baocui dough.

The effect of adding the edible oil and then mixing the dough is to make the dough more oily, to further ferment the dough and improve crispness of the pre-made baocui, and to facilitate uniformly heating the entire dough during subsequent frying, and to improve the mouthfeel of the pre-made baocui. The dough-mixing duration after addition of the edible oil may be adjusted according to actual needs, desired baocui mouthfeel and flavor etc. Preferably, the dough mixing duration may be 10-15 minutes.

Then, the process proceeds to step S118. At step, the method may further comprise: dividing the baocui dough into a plurality of cylinder sections, wherein a diameter of the cylinder sections is 10 cm and a height of the cylinder sections is 30-50 cm, and then wrapping the cylinder sections in plastic film and storing them in a refrigeration compartment of a refrigerator for 24-48 hours. Storing the cylinder sections in the refrigeration compartment may enable better mouthfeel of the pre-made baocui.

Then, the process proceeds to step S119. At step S119, dividing each cylinder section into a plurality of small pieces, and processing each of the small pieces into a sheet having a thickness of 1-3 mm.

Preferably, one or more of tools such as a rolling pin or a dough-pressing pin may be used to process the small piece into the sheet. The operator of the pre-made baocui may set the weight of each small piece as actually needed.

Then, the process proceeds to step S120. At step S120, the sheet obtained at step S119 is placed in an oil pot and deep-fried with oil at a temperature in a range of 180° C.-300° C. for 1-3 minutes to obtain the pre-made baocui.

The setting of the oil temperature may be adjusted as actually needed, wherein a high oil temperature is beneficial to shorten the processing duration of the pre-made baocui; a low oil temperature may avoid burning the pre-made baocui. The deep-frying duration may be selectively set according to the level of the oil temperature and the consumer's actual needs.

So far, the flow of processing the pre-made baocui is finished and the pre-made baocui is obtained.

The present disclosure further discloses a jianbing made from the following raw materials in parts by weight: 150 parts of mung bean flour, 50 parts of millet flour, 3 parts of salt, 0.6 parts of freshness and aroma enhancing powder, 1.5 parts of five-spice powder, and 300 parts of water, wherein the jianbing is made using step S101 through step S112 disclosed above. The jianbing may also be made using step S101 through step S120 disclosed above. Reference may be made to the content described above for the content of the respective steps, which will not be described in detail any more herein.

In another embodiment of the present disclosure, there is provided an apparatus for making jianbing, which may make jianbing by the method for making various jianbing described hereinabove.

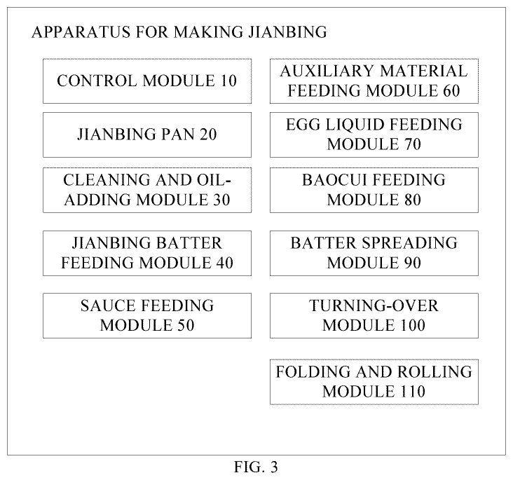

The apparatus for making jianbing will be described in detail with reference to FIG. 3 and comprises the following modules:
a control module 10 configured to control the apparatus to make jianbing by the method for making various jianbing described above;
a jianbing pan 20 configured to heat various raw materials and control the temperature, and rotate according to an instruction from the control module 10;
a cleaning and oil-adding module 30 configured to clean the jianbing pan 20 and add an appropriate amount of edible oil to the jianbing pan;
a jianbing batter feeding module 40 configured to store jianbing batter and feed the jianbing batter according to an instruction from the control module 10;
a sauce feeding module 50 configured to store sauce raw materials and feed the same according to an instruction from control module 10;
an auxiliary material feeding module 60 configured to store auxiliary materials and feed the auxiliary materials according to an instruction from the control module 10;
an egg liquid feeding module 70 configured to store egg liquid and feed the egg liquid according to an instruction from the control module 10;
a baocui feeding module 80 configured to store baocui and feed the baocui according to an instruction from the control module 10;
a batter spreading module 90 configured to spread or level a raw material placed on the jianbing pan 20 in a predetermined manner according to an instruction from the control module 10;
a turning-over module 100 configured to turn over the jianbing placed on the jianbing pan 20 according to an instruction from the control module 10;
a folding and rolling module 110 configured to fold or roll the jianbing according to an instruction from the control module 10.

In one embodiment of the present disclosure, the apparatus for making jianbing may comprise at least one robotic arm that cooperates with the above-described modules to implement operations such as feeding various raw materials, turning-over the jianbing and folding the jianbing.

In one embodiment of the present disclosure, the apparatus for making jianbing may further comprise a user interface that may receive a user input and transmit a customized parameter to the control module 10 according to the user input, such that the control module 10 completes the preparation of the jianbing according to the customized parameter.

In one embodiment of the present disclosure, the control module 10 activates heating of the jianbing pan 20 and keeps the jianbing pan 20 at a predetermined temperature. The cleaning and oil-adding module 30 cleans the jianbing pan 20 and adds an appropriate amount of edible oil on the jianbing pan 20.

In one embodiment of the present disclosure, the jianbing batter feeding module 40 may provide a stable and uniform supply of batter during jianbing making according to an instruction from the control module 10. The module is mainly composed of multiple components such as an ejecting mechanism, a flow rate regulator and an intelligent control system. The ejecting mechanism is used to precisely control the flow of the batter to ensure that the amount of batter supplied each time meets the making requirements. The flow rate regulator is responsible for regulating the flow rate of the batter so that the batter can flow out uniformly and stably, thereby making a jianbing with uniform thickness. The intelligent control system enables an operator to adjust the supply amount of the batter to meet personalized needs of different customers. By presetting parameters or adjusting manually, the operator may precisely control the supply of batter and improve the making efficiency.

In one embodiment of the present disclosure, the batter spreading module 90 may comprise a robotic arm and an inverted T-shaped spreading mechanism for spreading or leveling the jianbing batter in a predetermined manner. For example, the batter spreading module 90 may spread the jianbing batter evenly on the jianbing pan 20 by rotating the robotic arm and maintaining it for a period of time ranging from 10 to 30 seconds to ensure that the jianbing batter solidifies sufficiently to form a complete jianbing. The implementation of the function of the batter spreading module 90 may rely on the cooperation with the jianbing pan 20, specifically including cooperation with a batter spreading pan, a heating element and a drive mechanism, etc. in the jianbing pan 20.

In one embodiment of the present disclosure, the jianbing pan 20 may comprise a batter spreading pan for carrying and spreading the jianbing batter. The component is typically made of a material that is resistant to a high temperature and has good thermal conductivity to ensure uniform heating and solidification of the jianbing batter in a short period of time. In addition, the surface of the batter spreading pan may be specially treated to prevent adhesion of the batter and facilitate smooth removal of the jianbing.

In one embodiment of the present disclosure, the jianbing pan 20 may further comprise a drive mechanism for rotating or translating the jianbing pan during batter spreading to achieve uniform spreading of the batter. The drive mechanism may include mechanical components such as a motor, a gear, a belt, etc. It may be ensured that jianbing batter is distributed evenly on the batter spreading pan by precisely controlling the movement trajectory and speed of the batter spreading pan.

In one embodiment of the present disclosure, the egg liquid feeding module 70 may be implemented by the cooperation of the robotic arm and the ejecting mechanism, and used to cover at least a portion of the first surface of the jianbing with the egg liquid.

In one embodiment of the present disclosure, the auxiliary material feeding module 60 may be implemented by the cooperation of the robotic arm and a material spreading mechanism, and used to spread a pre-made material onto the at least a portion of the first surface.

In one embodiment of the present disclosure, the turning-over module 100 is used to turn over the jianbing so that the second surface of the jianbing contacts the jianbing pan 20.

In one embodiment of the present disclosure, the sauce feeding module 50 may be implemented by the cooperation of the robotic arm and the ejecting mechanism, and used to apply a predetermined amount of sauce on the second surface of the jianbing.

In one embodiment of the present disclosure, the baocui feeding module 80 may be implemented by the cooperation of the robotic arm and a baocui placement mechanism and used to place a pre-made baocui on the second surface of the jianbing.

In one embodiment of the present disclosure, the folding and rolling module 110 is used to roll the jianbing and the pre-made baocui together into a reel shape or fold the jianbing and the pre-made baocui together into a pancake shape.

In an embodiment of the present disclosure, the control module 10 is responsible for starting a heating process of the jianbing pan 20 and ensuring that its temperature is maintained at a preset constant value. The cleaning and oil-adding module 30 performs a cleaning operation on the jianbing pan 20, and then evenly applies an appropriate amount of edible oil on the surface of the pan to ensure the hygiene during the pan making process and the quality of the jianbing.

The jianbing batter feeding module 40 takes out a fixed amount of jianbing batter from a storage container according to an instruction from the control module 10 and places the jianbing batter uniformly on the jianbing pan 20. For example, the jianbing batter feeding module 40 may comprise an ejecting mechanism, and the jianbing batter feeding module 40 ejects the jianbing batter evenly on the surface of the jianbing pan 20 via the ejecting mechanism while the control module 10 controls the rotation of the jianbing pan 20. The batter spreading module 90 is responsible for spreading out the batter and maintaining it for a period of time to ensure that the batter solidifies sufficiently on the surface of the jianbing pan 20 to form a complete jianbing.

The egg liquid feeding module 70 then covers the first surface of the jianbing evenly with the egg liquid of the eggs. In one embodiment, the batter spreading module 90 may be responsible for spreading out the egg liquid and keeping for a period of time to ensure that the egg liquid solidifies sufficiently on the surface of the jianbing pan 20. Then, the auxiliary material feeding module 60 then spreads the pre-prepared auxiliary material on the first surface of the jianbing to enhance the flavor of the jianbing.

The turning-over module 100 turns over the jianbing such that the second surface opposite to the first surface is in contact with the jianbing pan 20. In one embodiment, the turning-over module 100 may comprise a lifting unit and a flipping unit to lift the jianbing first and then clamp the jianbing on the flipping unit for flipping, and then lay the jianbing flat on the surface of the jianbing pan 20, so that the second surface is in contact with the jianbing pan 20. The sauce feeding module 50 evenly applies a predetermined amount of sauce on the second surface of the jianbing according to an instruction from the control module 10.

The baocui feeding module 80 places the pre-made baocui on the second surface of the jianbing to improve the taste of the jianbing. For example, the baocui may be clamped by a robotic arm from a baocui placement shelf and placed in a middle area of the second surface of the jianbing. The folding and rolling module 110 then, according to an instruction from the control module 10, rolls the jianbing and the pre-made baocui together into a reel shape or fold the jianbing and the pre-made baocui together into a pancake shape for ease of eating and packaging.

The above steps are all completed under the unified control of the control module 10, achieve automatic or semi-automatic preparation of jianbing and ensure the whole preparation process smooth and efficient. The reference numbers help to understand specific positions and functions of the modules.

In another embodiment of the present disclosure, after the above-mentioned steps are completed, a cutting module may cut the jianbing rolled into a reel shape or folded into a pancake shape according to a pre-set size and shape, to ensure that the size of each portion of the jianbing is consistent. A packaging module then packages the duly-cut jianbing to maintain freshness and hygiene of the jianbing. Finally, a delivery module delivers the duly-packaged jianbing to a designated collection area for access by consumers.

In the depictions of the description, reference to terms “one embodiment”, “some embodiments”, “an example”, “a specific example”, or “some examples”, etc. means that specific features, structures, materials or characteristics described in conjunction with the embodiment or example is included in at least one embodiment or example of the present disclosure. Furthermore, the specific features, structures, materials or characteristics described may be combined in any suitable manner in any one or more embodiments or examples. Furthermore, in a case of no mutual contradiction, those skilled in the art may combine different embodiments or examples and features of the different embodiments or examples described in the present description.

In addition, the terms “first” and “second” are used for descriptive purposes only and are not to be construed as indicating or implying relative importance or as implicitly indicating the number of technical features indicated. Thus, a feature defined with “first” or “second” may explicitly or implicitly comprise at least one said feature. In the depictions of the present disclosure, the meaning of “a plurality” is two or more, unless specifically limited otherwise.

What are describe above are only example implementations of the present disclosure, but the protection scope of the present disclosure is not limited thereto; any of those skilled in the art can readily envisage other variations or substitutes which all should fall within the protection scope of the present disclosure without departing from the technical scope disclosed in the present disclosure. Therefore, the protection scope of the present disclosure should be determined by the protection scope of the claims.

1. A method for making jianbing, comprising the following steps:
taking batter raw materials in the following parts by weight: 150 parts of mung bean flour, 50 parts of millet flour, 3 parts of salt, 0.6 parts of freshness and aroma enhancing powder, 1.5 parts of five-spice powder, and 300 parts of water;
placing the mung bean flour, the millet flour, the salt, the freshness and aroma enhancing powder and the five-spice powder into a first vessel, and stirring uniformly to obtain a mixed raw material;
adding 180 parts of the water to the mixed raw material in the first vessel, and stirring uniformly to obtain a first batter;
adding remaining 120 parts of the water to the first batter and stirring uniformly to obtain a second batter;
sealing the first vessel containing the second batter with a thin film, and after letting the second batter stand still for 10-15 hours or over night, removing water from a surface layer to obtain a jianbing batter;
taking sauce raw materials in the following parts by weight: 50 parts of sweet bean sauce, 2.5 parts of honey, 2.5 parts of sugar and 10 parts of fermented tofu;
placing the sauce raw materials into a second vessel;
placing the second vessel in a steamer to steam for 2-8 minutes to obtain a sauce, or heating the second vessel to a temperature in a range of 150° C.-160° C. for 2-8 minutes to obtain a sauce;
heating the jianbing pan and continuously maintaining the jianbing pan at a predetermined temperature, taking a predetermined amount of the jianbing batter and placing the same on the jianbing pan, and uniformly spreading the jianbing batter and maintaining the jianbing batter for 10-30 seconds to solidify the jianbing batter into a jianbing;
covering at least a portion of a first surface of the jianbing with egg liquid of eggs and spreading a pre-made material on the at least a portion of the first surface;
turning the jianbing over so that the first surface of the jianbing is in contact with the jianbing pan, and applying a predetermined amount of the sauce on a second surface of the jianbing;
placing a pre-made baocui on the second surface of the jianbing and rolling the jianbing and the pre-made baocui together into a reel shape or folding them into a pankcake shape.

2. The method for making jianbing according to claim 1, wherein the pre-made baocui is made by the following steps:
taking baocui raw materials in the following parts by weight: 50 parts of flour, 1 part of salt, 1 part of You Tiao Jing, 0.5 parts of baking powder, 0.2 parts of baking soda, 3 parts of shortening, 5 parts of edible oil, 30 parts of water and one egg;
putting the flour, the salt, the You Tiao Jing, the baking powder, the baking soda and the water into a third vessel, and put egg liquid of the egg into the third vessel to obtain a first aqueous solution;
putting the first aqueous solution into a dough mixer, and mixing with the dough mixer for 2-6 minutes;
adding the shortening into the dough mixer, and mixing with the dough mixer for 1-10 minutes;
adding the edible oil into the dough mixer, and mixing with the dough mixer for 5-15 minutes to obtain a baocui dough;
dividing the baocui dough into a plurality of cylinder sections, wherein a diameter of the cylinder sections is 10 cm and a height of the cylinder sections is 30-50 cm, and then wrapping the cylinder sections in plastic film and storing them in a refrigeration compartment of a refrigerator for 24-48 hours;
dividing each cylinder section into a plurality of small pieces, and processing each of the small pieces into a sheet having a thickness of 1-3 mm;
placing the sheet in an oil pot and deep-frying the sheet with oil at a temperature in a range of 180° C.-300° C. for 1-3 minutes to obtain the pre-made baocui.

3. The method for making jianbing according to claim 1, wherein the batter raw materials further comprise 3 parts of fruit juice.

4. The method for making jianbing according to claim 1, wherein prior to placing the mung bean flour and the millet flour into the first vessel, passing the mung bean flour and the millet flour through a 120 mesh sieve.

5. The method for making jianbing according to claim 1, wherein the predetermined temperature is in a range of 150° C.-400° C.

6. The method for making jianbing according to claim 1, the pre-made material comprises: one or more of Chinese onion, coriander, meat product and fruit product.

7. The method for making jianbing according to claim 1, the method for making jianbing further comprises: breaking egg liquid of a predetermined number of eggs into a fourth vessel in advance, and stirring the egg liquid uniformly.

8. The method for making jianbing according to claim 1, the method for making jianbing further comprises heating the water to a temperature in a range of 30° C.-50° C.

9. The method for making jianbing according to claim 1, wherein the standing still for 10-15 hours or over night comprises: placing the first vessel duly-sealed with a thin film in a refrigeration compartment of a refrigerator for storing 10-15 hours or over night.

10. A jianbing made from raw materials in the following parts by weight: 150 parts of mung bean flour, 50 parts of millet flour, 3 parts of salt, 0.6 parts of fresh fragrance powder, 1.5 parts of five-spice powder, and 300 parts of water, wherein the jianbing is made by the method according to claim 1.

11. An apparatus for making jianbing, comprising:
a control module configured to control the apparatus to make jianbing by the method according to claim 1;
a jianbing pan configured to heat raw materials and control a temperature, and rotate according to an instruction from the control module;
a cleaning and oil-adding module configured to clean the jianbing pan and add an appropriate amount of edible oil to the jianbing pan;
a jianbing batter feeding module configured to store jianbing batter and feed the jianbing batter according to an instruction from the control module.
